(19) United States
(12) Patent Application Publication
(10) Pub. No.: US 2023/0349248 A1
(43) Pub. Date: Nov. 2, 2023

(54) CONTROL MODULE FOR USE WITH A WELLBORE TOOL AND WELLBORE TOOLSTRING WITH CONTROL MODULE

(71) Applicant: DynaEnergetics Europe GmbH, Troisdorf (DE)

(72) Inventors: Christian Eitschberger, Munich (DE); Andreas Robert Zemla, Much (DE); Sascha Thieltges, Siegburg (DE); Thilo Scharf, Letterkenny, Donegal (IE); Paula Feitoza Nascimento, Troisdorf (DE)

(73) Assignee: DynaEnergetics Europe GmbH, Troisdorf (DE)

(21) Appl. No.: 18/002,118

(22) PCT Filed: Jun. 15, 2021
(86) PCT No.: PCT/EP2021/066119

§ 371 Date: Dec. 16, 2022

Related U.S. Application Data
(60) Provisional application No. 63/040,393, filed on Jun. 17, 2020.

(51) Int. Cl. E21B 23/00; E21B 47/07; H01H 35/24

(52) U.S. Cl. CPC E21B 23/00; E21B 47/07; H01H 35/24

(57) ABSTRACT

A control module for use with a plurality of wellbore tools may include a power source and a logic circuit operably coupled to the power source. The logic circuit may be operably coupled to the plurality of wellbore tools through a topmost wellbore tool of the plurality of wellbore tools. The logic circuit may be configured to, in response to an initiation condition and for each wellbore tool of the plurality of wellbore tools in a sequential order from a bottommost wellbore tool to the topmost wellbore tool, determine whether the wellbore tool is a responsive wellbore tool or a non-responsive wellbore tool. In response to a determination that the wellbore tool is a responsive wellbore tool, the logic circuit may initiate the wellbore tool. In response to a determination that the wellbore tool is a non-responsive wellbore tool, the logic circuit may skip initiation of the wellbore tool.

### CROSS-REFERENCE TO RELATED APPLICATIONS

The present application claims priority to U.S. Provisional Patent Application No. 63/040,393 filed Jun. 17, 2020, the contents of which are incorporated herein by reference.

### BACKGROUND OF THE DISCLOSURE

Hydrocarbons, such as fossil fuels (e.g. oil) and natural gas, may be extracted from underground wellbores extending deep below the surface using complex machinery and explosive devices. Once the wellbore is established by placement of cases after drilling, a perforating gun assembly, or train or string of multiple perforating gun assemblies, may be lowered into the wellbore and positioned adjacent one or more hydrocarbon reservoirs in underground formations. Shaped charges may then be initiated to blast through the formation so that the hydrocarbons can flow through from the formation into the wellbore.

One possible system for initiating the shaped charges may include pressure-activated perforating guns that are typically initiated by applying fluid pressure through coiled tubing to a firing pin. Conventional systems may include a pyrotechnic time delay fuse located within the firing pin holder. The firing pin holder may be connected to a top sub, which may include a booster and a detonating cord. At one end of the perforating gun assembly, the firing pin holder may include a piston and a percussion initiator. Between the firing pin holder and a tandem sub assembly, one or more multiple time delay subs may be positioned.

The pyrotechnic time delay device may interpose a time delay between the initiation of the firing pin holder and the firing of the shaped charges carried by the perforating gun assembly. However, because pyrotechnic time delay devices rely on the pace of a deflagration chemical reaction, the actual length of the time delay may vary based on the physical environment of the wellbore, such as wellbore temperature. Accurate setting of a pyrotechnic time delay may rely heavily on user expertise and complicated time-temperature charts. Additionally, pyrotechnic time delay devices inherently require the use of combustible and/or explosive components. Accordingly, pyrotechnic time delay devices may pose a safety hazard to workers, and often require the device to be assembled on-site instead of being shipped.

Accordingly, there may be a need for a control module for use with a wellbore tool string that can initiate a wellbore tool string based on a pressure without requiring the use of a pyrotechnic delay device.

### BRIEF DESCRIPTION OF EXEMPLARY EMBODIMENTS

An exemplary embodiment of a control module for use with a wellbore tool may include a power source and a logic circuit operably coupled to the power source. The logic circuit may be operably coupled to the plurality of wellbore tools through a topmost wellbore tool of the plurality of wellbore tools. The logic circuit may be configured to, in response to an initiation condition and for each wellbore tool of the plurality of wellbore tools in a sequential order from a bottommost wellbore tool to the topmost wellbore tool, determine whether the wellbore tool is a responsive wellbore tool or a non-responsive wellbore tool. In response to a determination that the wellbore tool is a responsive wellbore tool, the logic circuit may initiate the wellbore tool. In response to a determination that the wellbore tool is a non-responsive wellbore tool, the logic circuit may skip initiation of the wellbore tool.

An exemplary embodiment of a wellbore tool string may include a control module and a plurality of wellbore tools operably coupled in sequence, a topmost wellbore tool of the plurality of wellbore tools being operably coupled to the control module. Each wellbore tool of the plurality of wellbore tools may be selectively addressable. The control module may include a power source and a logic circuit operably coupled to the power source. The logic circuit may be operably coupled to the plurality of wellbore tools through the topmost wellbore tool. The logic circuit may be configured to, in response to an initiation condition and for each wellbore tool of the plurality of wellbore tools in a sequential order from a bottommost wellbore tool to the topmost wellbore tool, determine whether the wellbore tool is a responsive wellbore tool or a non-responsive wellbore tool. In response to a determination that the wellbore tool is a responsive wellbore tool, the logic circuit may initiate the wellbore tool. In response to a determination that the wellbore tool is a non-responsive wellbore tool, the logic circuit may skip initiation of the wellbore tool.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a schematic block diagram of a tool string according to an exemplary embodiment;

FIG. 2 is a side view of a control module according to an exemplary embodiment;

FIG. 3 is an end view of a control module according to an exemplary embodiment;

FIG. 4 is a cross section of the control module of FIG. 3 along line 4 according to an exemplary embodiment;

FIG. 5 is a cross section of the control module of FIG. 3 along line 5 according to an exemplary embodiment;

FIG. 6 is an enlarged view of the cross section of the control module of FIG. 4 according to an exemplary embodiment;

FIG. 7 is a perspective view of a pressure-actuated safety switch according to an exemplary embodiment;

FIG. 8 is a schematic block diagram of a control module according to an exemplary embodiment;

FIG. 9 is a schematic block diagram of a control module according to an exemplary embodiment;

FIG. 10 is a flowchart diagram of a control method according to an exemplary embodiment; and

FIG. 11 is a side view of a control module according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to emphasize specific features relevant to some embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various embodiments. Each example is provided by way of explanation and is not meant as a limitation and does not constitute a definition of all possible embodiments.

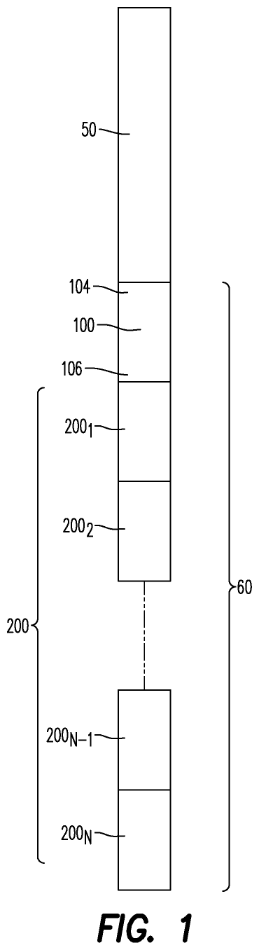

FIG. 1 shows an exemplary embodiment of a tool string 60 attached to a tubing 50 for use in a wellbore. The tool string 60 may include a control module 100 and one or more wellbore tools 200. The control module 100 may include a first end 104 operably coupled to the tubing 50 and a second end 106 operably coupled to a topmost wellbore tool 200₁ of the wellbore tools 200. The wellbore tools may include a total of N wellbore tools, N being an integer, sequentially coupled from the topmost wellbore tool 200₁ to a bottommost wellbore tool 200_{N}. The wellbore tools may include tools such as, but not limited to, perforating guns, setting tools, packers, plug tools, punch tools, cutting tools, or other tools or devices that may be used within a wellbore. In an exemplary embodiment, the wellbore tools 200 may be a string of perforating guns.

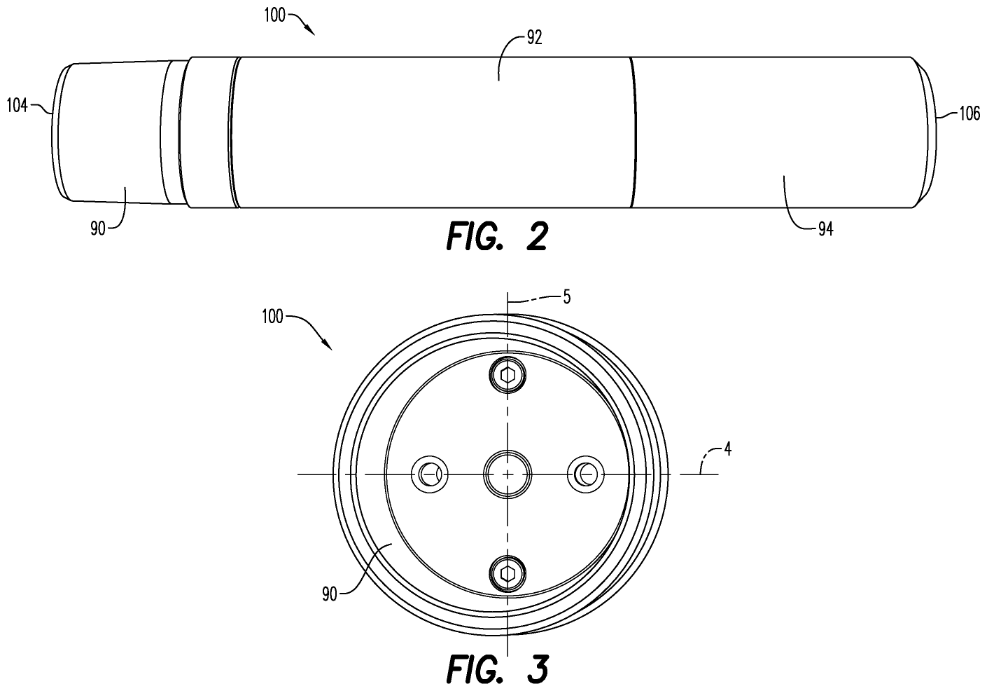

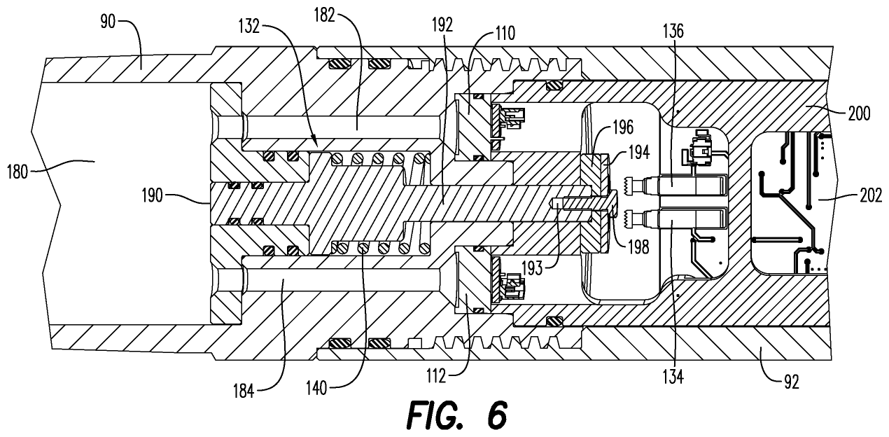

FIGS. 2-6 show an exemplary embodiment of the control module 100. The control module 100 may include a top housing 90, a middle housing 92, and a bottom housing 94. The top housing 90 may be dimensionally configured to couple with the tubing 50. In this context, the terms “top,” “middle,” and “bottom” refer to a relative position of the top housing 90, the middle housing 92, and the bottom housing 94 within a wellbore with respect to the surface, but do not necessarily reflect positions with respect to gravity.

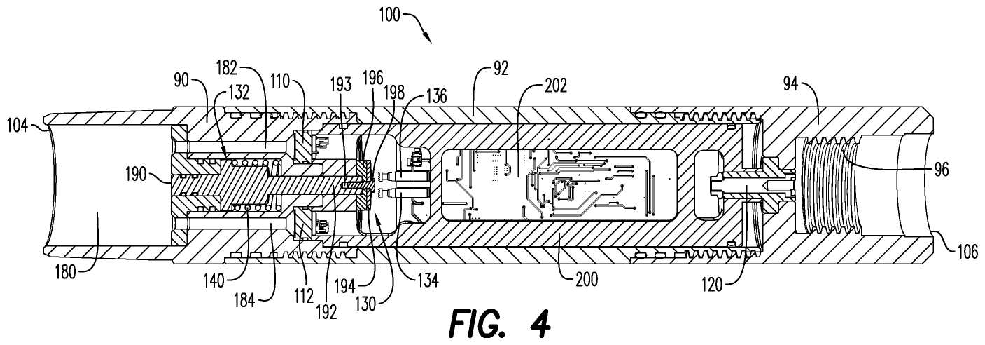

As seen in FIGS. 4-6, the control module 100 may include a first cavity 180 in fluid communication with the tubing 50. In other words, a pressure within the first cavity 180 may be equal to a tubing pressure applied through the tubing 50. While the phrases “tubing pressure” and “tubing 50” are used, it will be understood that these phrases may also include applications using an annulus or coil tubing. In other words, tubing 50 may also include an annulus or coil tubing, and the phrase “tubing pressure” may include annulus pressure or coil tubing pressure. The control module 100 may further include a pressure sensor 132. According to an aspect, the pressure sensor 132 is a mechanical pressure sensor. The mechanical pressure sensor 132 may include a pressure sensor surface 190 in fluid communication with the first cavity 180. The mechanical pressure sensor 132 may further include a piston 192 integrally formed with or mechanically coupled to the pressure sensor surface 190. The mechanical pressure sensor 132 may further include a bias member 140, such as a spring, configured to applying a biasing force to the mechanical pressure sensor 132 toward the first end 104. When the pressure in the first cavity 180 exceeds a first threshold sufficient to overcome the biasing force of the bias member 140, the mechanical pressure sensor 132 is pushed in a direction toward the second end 106 to close pressure-actuated safety switch 130, which is described in further detail herein.

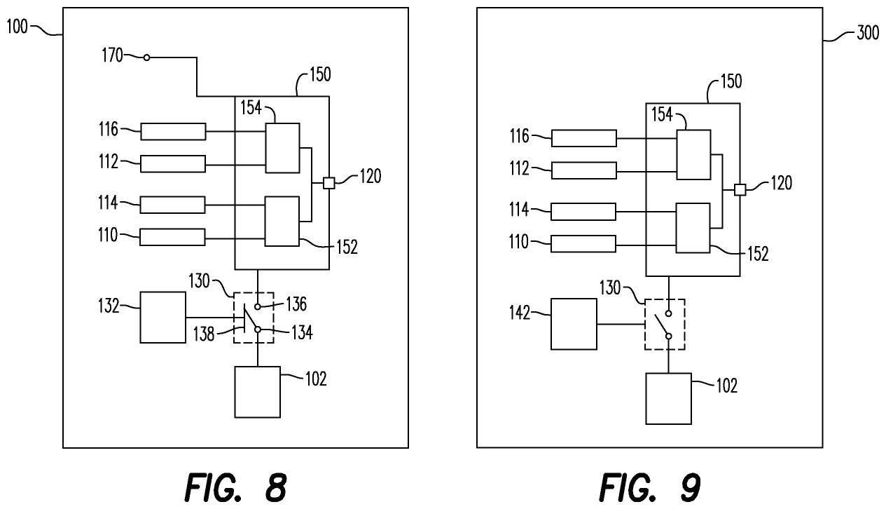

FIGS. 4-6 further illustrate that an exemplary embodiment of the control module 100 may include a frame 200 configured to mount a circuit board 202. The circuit board 202 may include a logic circuit 150 (see FIG. 8). As further seen in FIG. 8, when the pressure-actuated safety switch 130 is closed, power is supplied to the logic circuit 150 from a power source 102. The power source 102 may be battery such as a lithium ion battery or another electrical power storage device. The power source 102 may be mounted on the circuit board 202 or separately mounted within the control module 100.

Returning to FIGS. 4-6, the control module 100 may further include a first pressure sensor 110 and a second pressure sensor 112. The first pressure sensor 110 and the second pressure sensor 112 may be in fluid communication with the first cavity 180 via a first pressure channel 182 and a second pressure channel 184. The first pressure sensor 110 and the second pressure sensor 112 may be operably coupled to the logic circuit 150 via cables (not shown) or other suitable connection. The first pressure sensor 110 and the second pressure sensor 112 may be powered via the logic circuit 150 once the pressure-actuated safety switch 130 is closed. Alternatively, the first pressure sensor 110 and the second pressure sensor 112 may be provided with their own power supply, i.e., directly connected to the power source 102 or powered by a separate power source.

The first pressure sensor 110 and the second pressure sensor 112 may be configured to detect a pressure, such as a tubing pressure or a wellbore pressure. In an exemplary embodiment, the first pressure sensor 110 may be configured to detect the pressure (via the first pressure channel 182 and the first cavity 180) and output a first sensor output signal to the logic circuit 150 based on the pressure. The second pressure sensor 112 may be configured to detect the pressure (via the second pressure 184 and the first cavity 180) and output a second sensor output signal to the logic circuit 150 based on the pressure. The first sensor output signal and the second sensor output signal may be electronic signals. The logic circuit 150 may be configured to output an operation signal for controlling the wellbore tools 200 based on the first sensor output signal and/or the second sensor output signal. In other words, the initiation condition may comprise the first sensor output signal and/or the second sensor output signal indicating that the pressure is within a predetermined pressure range. On the other hand, if the first sensor output signal and/or the second sensor output signal are outside the predetermined pressure range, the logic circuit 150 may block or prevent initiation of any wellbore tool 200.

In an exemplary embodiment, the logic circuit 150 may be configured to perform certain actions in response to an initiation condition. For example, in response to the initiation condition, the logic circuit 150 may, for each wellbore tool 200ᵢ, i being an integer, of the plurality of wellbore tools 200 in a sequential order from the bottommost wellbore tool 200_{N} to the topmost wellbore tool 200ᵢ, determine whether the wellbore tool 200ᵢ is a responsive wellbore tool or a non-responsive wellbore tool (responsive and non-responsive wellbore tools are discussed in further detail herein). In response to a determination that the wellbore tool 200ᵢ is a responsive wellbore tool, the logic circuit 150 may initiate the wellbore tool 200ᵢ. In response to a determination that the wellbore tool 200ᵢ is a non-responsive wellbore tool, the logic circuit 150 may skip initiation of the wellbore tool 200ᵢ or take steps to block initiation of or deactivate wellbore tool 200ᵢ. In other words, the logic circuit 150 may be configured to start at a bottommost wellbore tool 200_{N}, and sequentially initiation wellbore tools 200 from the bottom up, checking each wellbore tool 200 to ensure that it is responsive and operable. Overall, this allows the logic circuit 150 to autonomously initiate a plurality of wellbore tools 200 without requiring the use of a pyrotechnic time delay fuse. Additionally, the ability to skip or block initiation of non-responsive and/or inoperable wellbore tools may improve the safety, reliability, and efficiency of the perforating operation.

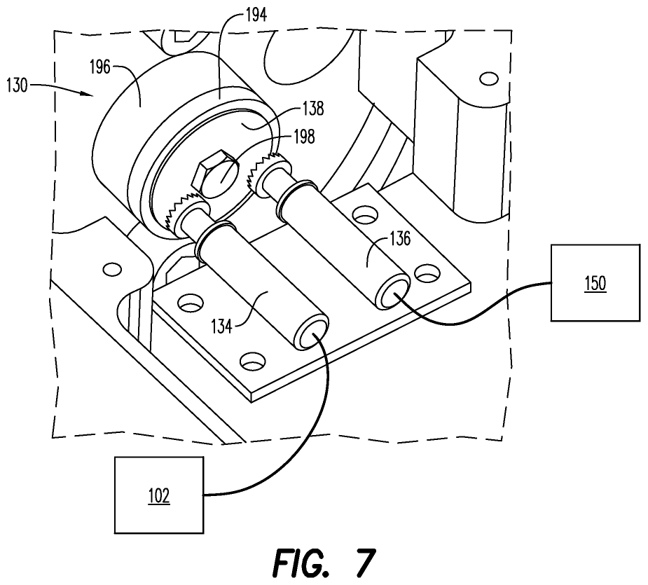

FIG. 7 shows an exemplary embodiment of the pressure-actuated safety switch 130. The pressure-actuated safety switch 130 may include a first electrical contact 134 operably coupled to the power source 102, a second electrical contact 136 operably coupled to the logic circuit 150, and a third electrical contact 138. The third electrical contact 138 may be mounted on a second circuit board 194, which may be mounted on a backing disk 196 for mechanical support. The second circuit board 194 and the backing disk 196 may be mounted on the piston 192 shown in FIGS. 4-6 via a screw 198 inserted into a hole 193 provided in an end of the piston 196 (see FIGS. 4-6). When the pressure exceeds the first threshold so as to overcome the biasing force of the bias member 140 (see FIGS. 4-6), the mechanical pressure sensor 132 pushes the third electrical contact 138 into contact with the first electrical contact 134 and the second electrical contact 136, thereby closing the pressure-actuated safety switch 130. In other words, the bias member 140 (see FIGS. 4-6) biases the third electrical contact 138 toward a first position in which the third electrical contact 138 is separated from the first electrical contact 134 and the second electrical contact 136, and the third electrical contact 138 moves to a second position in which the third electrical contact 138 is in contact with the first electrical contact 134 and the second electrical contact 136 in response to the pressure exceeding the biasing force of the bias member 140.

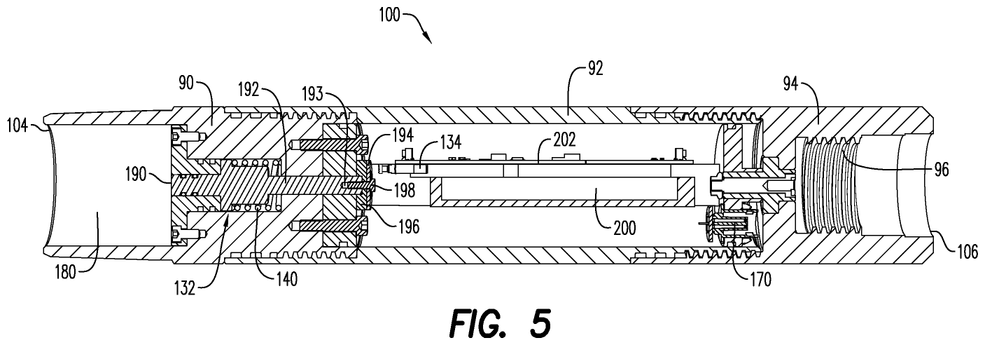

Returning to FIGS. 4-5, the control module 100 may further include an output terminal 120 operably coupled to the logic circuit 150. The topmost wellbore tool 200₁ may be operably coupled to the output terminal 120. Accordingly, the operation signal output by the logic circuit 150 may be transmitted to the topmost wellbore tool 200₁ via the output terminal 120. The remaining wellbore tools 200 may be operably coupled with the topmost wellbore tool 200₁ via through lines and/or switches such that any operation signal received by the topmost wellbore tool 200₁ may be passed through and selectively received by any of the wellbore tools 200.

As further seen in FIG. 5, the control module 100 may include a test interface 170. The test interface 170 may be operably coupled to the logic circuit 150 (see, for example, FIG. 8). The test interface 170 may be configured to couple with a computer such as a testing terminal or a firing computer to receive a test signal such as simulated pressure and environment condition signals to test that the logic circuit 150 properly controls the operation signal in response to various simulated conditions.

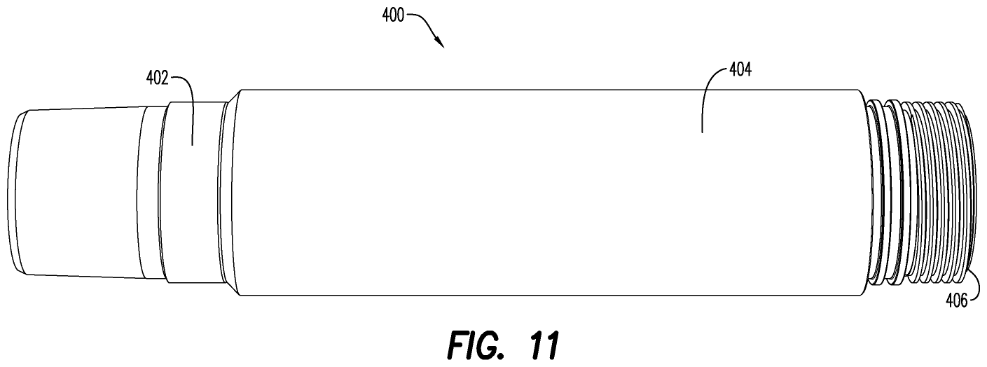

As further seen in FIGS. 4-5, the control module 100 may include female threading 96 provided in the bottom housing 94. The female threading 96 may be configured to couple with a top sub adapter (not shown). It will be understood that the body of the control module 100 is not limited to what is shown in FIGS. 2-5. For example, the control module 100 may include less than three housings or more than three housings. Additionally, the second end 106 of the control module 100 may include male threading instead of the female threading 96. For example, FIG. 11 shows an exemplary embodiment of a control module 400 that includes a top housing 402 and a bottom housing 404. The bottom housing 404 may include a male threading 406. The male threading 406 may directly couple directly with a wellbore tool without the use of a top sub adapter.

FIG. 8 shows an exemplary embodiment of the logic circuit 150. The logic circuit 150 may include an integrated circuit such as a first microcontroller 152 and a second microcontroller 154. The first microcontroller 152 may be operably coupled to the first pressure sensor 110, and the second microcontroller 154 may be operably coupled to the second pressure sensor 112. This may allow for independent measurement and verification of the pressure as an added safety measure.

As further seen in FIG. 8, the control module 100 may further include a first environment sensor 114 operably coupled to the first microcontroller 152 and a second environment sensor 116 operably coupled to the second microcontroller 154. The first environment sensor 114 may be configured to detect a first environment condition and output a first environment signal based on the first environment condition. The second environment sensor 116 may be configured to detect the first environment condition and output a second environment signal based on the first environment condition. The combination of the first environment sensor 114 and the second environment sensor 116 may allow for independent measurement and verification of the first environment condition. The first environment condition may be a temperature of the wellbore environment, or motion or vibration of the wellbore tool string. In an exemplary embodiment, the first environment sensor 114 and the second environment sensor 116 may be temperature sensors, motion sensors, or vibration sensors. Accordingly, the first environment condition may be a predetermined temperature range, a maximum motion threshold, or a maximum vibration threshold.

FIG. 9 shows an exemplary embodiment of a control module 300. The logic circuit may be configured to vary the operation signal in response to variations in the amplitude and/or frequency pressure. The control module 300 differs from the control module 100 in that the mechanical pressure sensor 132 of the control module 100 is replaced with an electronic pressure sensor 142 in the control module 300. The electronic pressure sensor 142 may be independently powered or may be powered via the power source 102. The electronic pressure sensor 142 may output an electrical signal based on the pressure to the pressure actuated switch 130. The pressure-actuated safety switch 130 may include circuitry configured to receive and process the output from the electronic pressure sensor 142 and close the switch when the pressure exceeds an initial pressure threshold. In an alternative exemplary embodiment, the pressure-actuated safety switch 130 may rely on a signal from one or both of the first pressure sensor 110 and the second pressure sensor 112 instead of electronic pressure sensor 142.

The operation signal output by the logic circuit may be used to select and/or initiate one or more of the wellbore tools 200. The wellbore tools 200 may each include control circuitry configured to selectively initiate each individual wellbore tool 200 in response to the operation signal received by the wellbore tools. In other words, a user may control the pressure to control the operation signal output by the logic circuit 150 to select and initiate one of the wellbore tools 200. Alternatively, the logic circuit 150 may be configured to select and initiate the wellbore tools 200 in a predetermined sequence once the logic circuit 150 becomes coupled to the power source 102. In an exemplary embodiment, the wellbore tools 200 may be a plurality of perforating guns, and the control circuitry may be an electronic initiation circuit as disclosed in U.S. Pat. No. 9,915,513, which is incorporated herein by reference in its entirety to the extent that it is consistent with this disclosure. In other words, each wellbore tool 200 may be selectively addressable by the logic circuit 150.

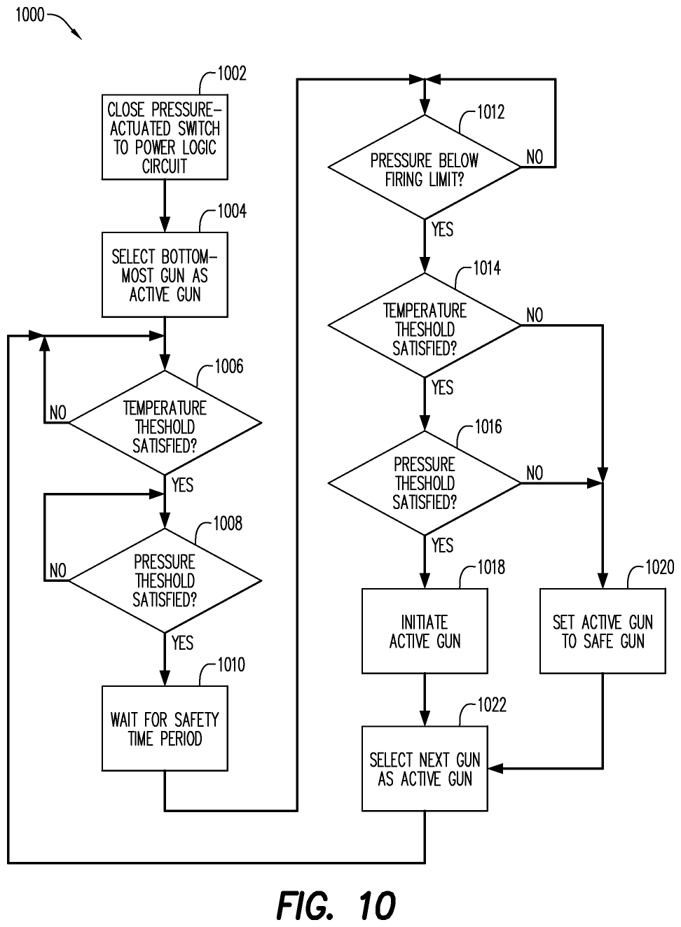

FIG. 10 illustrates an exemplary embodiment of a control method 1000 for use by the control module 100. In block 1002, the pressure-actuated safety switch 130 is closed and the logic circuit 150 is powered. In block 1004, the logic circuit 150 selects the bottommost gun 200_{N} as the active gun.

In block 1006, the logic circuit determines whether a temperature threshold is satisfied. The temperature of the wellbore environment may be measured by one or both of the first environment sensor 114 and the second environment sensor 116. In an exemplary embodiment, the temperature threshold may be satisfied if the wellbore temperature is 65° C. or higher. However, it will be understood that the control method 1000 is not limited to this temperature threshold, and the temperature threshold may vary depending on factors such as geologic formation, depth, type of well, and/or type of wellbore operation being performed. If the temperature threshold is satisfied (“yes” at block 1006), then the control method 1000 proceeds to block 1008. If the temperature threshold is not satisfied (“no” at block 1006), the control method 1000 repeats the measurement and evaluation of the wellbore temperature.

In block 1008, it is determined whether a pressure threshold is satisfied. The pressure may be measured by one or both of the first pressure sensor 110 and/or the second pressure sensor 112. In an exemplary embodiment, the pressure threshold may be satisfied if the pressure is 35 bar or higher. However, it will be understood that the control method 1000 is not limited to this pressure threshold, and the pressure threshold may vary depending on factors such as geologic formation, depth, type of well, and/or type of wellbore operation being performed. If the pressure threshold is satisfied (“yes” at block 1008), then the control method 1000 proceeds to block 110. If the pressure threshold is not satisfied (“no” at block 1008), the control method 1000 repeats the measurement and evaluation of the pressure.

In block 1010, the logic circuit 150 waits for a predetermined safety time period. In other words, the predetermined safety time period allows the logic circuit to implement a predetermined delay between initiation of consecutive wellbore tools 200. In an exemplary embodiment, the safety time period may be independently measured by the first microcontroller 152 and the second microcontroller 154 as a redundancy method for safety purposes. In an exemplary embodiment, the safety time may be 15 minutes. However, it will be understood that the control method 1000 is not limited to this embodiment, and the safety time period may be preprogrammed to any desired value based on the requirements of the specific wellbore operation being implemented.

In block 1012, it is determined whether the pressure is below a predetermined firing limit. In an exemplary embodiment, the predetermined firing limit may be 500 bar. However, it will be understood that the predetermined firing limit is not limited to this value and may be varied depending on the specific application. If the pressure is below the predetermined firing limit (“yes” in block 1012), then the control method 1000 proceeds to block 1014. If the pressure is not below the predetermined firing limit (“no” in block 1012), then the control method 1000 proceeds repeats the measurement and evaluation of the pressure.

In block 1014, it is determined whether a temperature threshold is satisfied. The temperature threshold in block 1014 may be the same as the temperature threshold in block 1006 or may be different. If the temperature threshold is satisfied (“yes” at block 1014), then the control method proceeds to block 1016. If the temperature threshold is not satisfied (“no” at block 1014), then the control method 1000 proceeds to block 1020.

In block 1016, it is determined whether a pressure threshold is satisfied. The pressure threshold in block 1016 may be the same as the pressure threshold in block 1008 or may be different. If the pressure threshold is satisfied (“yes” at block 1016), then the control method proceeds to block 1018. If the pressure threshold is not satisfied (“no” at block 1016), then the control method proceeds to block 1020.

In block 1018, the logic circuit 150 controls the operation signal to initiate the active gun. In other words, the logic circuit 150 may control the operation signal such that a wellbore tool 200 is initiated in response to the first sensor output signal and/or the second sensor output signal indicating that the pressure satisfies a first pressure threshold as determined in the block 1016. Additionally and/or alternatively, the logic circuit may be configured to control the operation signal such that a wellbore tool 200 is initiated in response to the first environment signal and/or the second environment signal indicating that the environment condition satisfies a first environment threshold, as determined in block 1014.

In block 1020, the active gun is entered in a safe state. For example, the active gun may be disarmed and/or deactivated. In other words, the logic circuit 150 may control the operation signal to block initiation of a wellbore tool 200 in response to first sensor output signal and/or the second sensor output signal indicating that the pressure is outside a predetermined safe pressure range, as determined in block 1012 and/or block 1016. Additionally and/or alternatively, the logic circuit 150 may control the operation signal such that initiation of the wellbore tool 200 is blocked in response to the first environment signal and/or the second environment signal indicating that the first environment condition is outside a predetermined safe environment condition range, as determined in block 1014. In other words, the initiation condition may comprise the first environment signal and/or the second environment signal indicating that the first environment signal and/or the second environment signal is outside the predetermined safe environment condition range or environment threshold.

In block 1022, the logic circuit 150 controls the operation signal to sequentially select the next gun as the active gun. For example, if the bottommost gun (wellbore tool 200_{N}) was the previous active gun that was initiated or put into a safe state, then the next gun would be the next higher gun, i.e., wellbore tool 200_{N-1}. The control method then returns to block 1006. In other words, the logic circuit 150 may be configured so as to sequentially select and initiate each wellbore tool 200 in a direction from the bottommost wellbore tool 200_{N} to the topmost wellbore tool 200₁.

It will be understood that the control method 1000 and operation of the logic circuit 150 are not limited to the specific blocks and/or order of blocks as illustrated in FIG. 10. For example, it will be understood that the blocks may be performed in a different sequence, or that the operations of different blocks may be performed in parallel to each other. Additionally, it will be understood that the control method 1000 and/or the operation of the logic circuit may include less all of the blocks shown in FIG. 10 or additional blocks not illustrated in FIG. 10. For example, in an exemplary embodiment in which the logic circuit 150 includes the first microcontroller 152 and the second microcontroller 154, the first microcontroller 152 and the second microcontroller 154 may be used to independently detect and verify conditions such as pressure, temperature, and/or safety timing period.

For example, and as shown in FIG. 8, the first microcontroller 152 may be operably coupled to the first pressure sensor 110 and the second microcontroller 154 may be operably coupled to the second pressure sensor 112. The logic circuit 150 may be configured to initiate a wellbore tool 200 only if the first microcontroller 152 determines that the first sensor output signal from the first pressure sensor 110 indicates that the pressure satisfies the pressure threshold and the second microcontroller 154 determines that the second sensor output signal from the second pressure sensor 112 indicates that the pressure satisfies the pressure threshold. Alternatively, in an exemplary embodiment, a single microcontroller may be operably coupled to both the first pressure sensor 110 and the second pressure sensor 112, and the single microcontroller may determine whether the first sensor output signal and the second sensor output signal indicate a pressure that satisfies the first pressure threshold.

Similarly, the first microcontroller 152 may be operably coupled to the first environment sensor 114 and the second microcontroller may be operably coupled to the second environment sensor 116. The logic circuit 150 may be configured to initiate a wellbore tool only if the first microcontroller determines that the first environment signal from the first environment sensor indicates that the environment condition satisfies the environment threshold and the second microcontroller determines that the second environment signal from the second environment sensor indicates that the environment condition satisfies the environment threshold. Alternative, in an exemplary embodiment, a single microcontroller may be operably coupled to both the first environment sensor 114 and the second environment sensor 116, and the single microcontroller may determine whether the first environment signal and the second environment signal indicate that the environment condition satisfies the environment threshold.

Additionally, in an exemplary embodiment, the logic circuit 150 may be configured to initiate a wellbore tool only in response to all of the first sensor output signal, the second sensor output signal, the first environment signal, and the second environment signal satisfying the corresponding thresholds. Further, the logic circuit 150 may be configured such that different measurements of the same condition must be within a predetermined range of each other before initiation may occur. For example, the logic circuit may be configured to determine whether the first sensor output signal and the second sensor output signal are within a predetermined pressure range of each other, whether the first environment signal and the second environment signal are within a predetermined range of each other, and/or whether a first timing (such as the safety time period of block 1010 in FIG. 10) and a second timing are within a predetermined timing threshold of each other.

Additionally, in an exemplary embodiment, the control circuitry of each wellbore tool 200 may be configured to send a return signal to the logic circuit 150 indicating a status of the wellbore tool. Alternatively, the logic circuit 150 may be configured to determine a status of each wellbore tool 200 based on a current draw or voltage change when each wellbore tool 200 is made active. The logic circuit 150 may be configured to determine whether such return signal, current draw, or voltage change is outside of a normal operating range (for example, due to damage of the circuitry or rupture of a pressure seal in the wellbore tool), in which case the logic circuit 150 may designate the corresponding wellbore tool 200 as a non-responsive wellbore tool. The logic circuit 150 may be configured such that, if the wellbore tool 200 is non-responsive, then the logic circuit 150 skips initiation of the non-responsive wellbore tool and proceeds to the next wellbore tool 200 in the sequence. If the corresponding wellbore tool 200 has a return signal, current draw, or voltage change within the normal operating range, then the logic circuit 150 may determine that the corresponding wellbore 200 is a responsive wellbore tool.

Additionally, in an exemplary embodiment, the logic circuit 150 may be configured to wait for a predetermined startup time delay following the closing of the pressure actuated switch 130. The predetermined startup time delay may be separately calculated and tracked by the first microcontroller 152 and the second microcontroller 154.

As described herein, the use of the logic circuit 150 within the control module 100 may provide a system by which time delays can be reliably implemented in a pressure-activated tool string without the use of a pyrotechnic delay device. The elimination of the pyrotechnic delay device may help to improve reliability and consistency of the wellbore tools, as well as reduce the time and cost needed of assembling the pyrotechnic delay devices on-site. Additionally, the inclusion of the first pressure sensor 110, the second pressure sensor 112, the first environment sensor 114, and the second environment sensor 116 helps to ensure that the wellbore tools 200 are only initiated under proper environmental conditions, thereby increasing safety as well as improving reliability and retrievability of the wellbore tools 200. Non-limiting examples of environmental conditions may include tubing pressure, wellbore pressure, and/or downhole temperature. Further, the inclusion of multiple pressure sensors, multiple environment sensors and/or multiple microcontrollers helps to provide a layer of redundancy that improves safety and reliability. Further, the inclusion of a pressure-activated coupling of the logic circuit 150 to the power source 102 may help to ensure safety by preventing any arming or initiation of wellbore devices under surface conditions.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

Embodiments of the disclosure are operational with numerous other general purpose or special purpose computing system environments or configurations. Examples of computing systems, environments, and/or configurations that may be suitable for use with the systems and methods described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The embodiments of the disclosure may be described in the general context of computer-executable instructions, such as program modules, being executed by a computer. Generally, program modules may include routines, programs, objects, components, data structures, etc. that perform particular tasks or implement particular abstract data types. The systems and methods described herein may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

The phrases “at least one,” “one or more,” and “and/or” are open-ended expressions that are both conjunctive and disjunctive in operation. For example, each of the expressions “at least one of A, B and C;” “at least one of A, B, or C;” “one or more of A, B, and C;” “one or more of A, B, or C;” and “A, B, and/or C” means A alone; B alone; C alone; A and B together; A and C together; B and C together; or A, B, and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment,” “some embodiments,” “an embodiment,” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine,” “calculate,” “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

1. A control module for use with a plurality of wellbore tools, the control module comprising:
a power source;
a logic circuit operably coupled to the power source;
wherein the logic circuit is operably coupled to the plurality of wellbore tools through a topmost wellbore tool of the plurality of wellbore tools; and
the logic circuit is configured to, in response to an initiation condition:
for each wellbore tool of the plurality of wellbore tools in a sequential order from a bottommost wellbore tool to the topmost wellbore tool, determine whether the wellbore tool is a responsive wellbore tool or a non-responsive wellbore tool;
in response to a determination that the wellbore tool is a responsive wellbore tool, initiate the wellbore tool; and
in response to a determination that the wellbore tool is a non-responsive wellbore tool, skip initiation of the wellbore tool.

2. The control module of claim 1, wherein:
the control module further comprises a first pressure sensor operably coupled to the logic circuit, the first pressure sensor being configured to detect a pressure and output a first sensor output signal based on the pressure; and
the initiation condition comprises the first sensor output signal indicating that the pressure is within a predetermined pressure range.

3. The control module of claim 2, the logic circuit is configured to, in response to the first sensor output signal indicating that the pressure is outside the predetermined pressure range, prevent initiation of any wellbore tool of the plurality of wellbore tools.

4. The control module of claim 2, further comprising:
a second pressure sensor operably coupled to the logic circuit, the second pressure sensor being configured to detect the pressure and output a second sensor output signal based on the pressure;
wherein the logic circuit further comprises:
a first microcontroller operably coupled to the first pressure sensor, the first microcontroller being configured to determine whether the first sensor output signal indicates that the pressure is within the predetermined pressure range; and
a second microcontroller operably coupled to the second pressure sensor, the second microcontroller being configured to determine whether the second sensor output signal indicates that the pressure is within the predetermined pressure range; and
wherein the initiation condition further comprises the second sensor output signal indicating that the pressure is within the predetermined pressure range.

5. The control module of claim 2, wherein the pressure is a tubing pressure or a wellbore pressure.

6. The control module of claim 1, wherein:
the control module further comprises a pressure-actuated safety switch operably coupled between the power source and the logic circuit, the pressure-actuated safety switch being configured to close and operably couple the power source to the logic circuit in response to a pressure exceeding a first pressure threshold.

7. The control module of claim 6, wherein the pressure-actuated safety switch comprises:
a first electrical contact operably coupled to the power source and a second electrical contact spaced apart from the first electrical contact and operably coupled to the logic circuit;
a third electrical contact movable between a first position, in which the third electrical contact is separated from the first electrical contact and the second electrical contact, and a second position, in which the third electrical contact is in contact with the first electrical contact and the second electrical contact thereby operably coupling the first electrical contact to the second electrical contact; and
a bias member configured to bias the third electrical contact toward the first position.

8. The control module of claim 1, wherein
the logic circuit further comprises a first microcontroller;
a first environment sensor operably coupled to the first microcontroller, the first environment sensor being configured to detect a first environment condition and output a first environment signal based on the first environment condition; and
the initiation condition comprises the first environment signal indicating that the first environment condition satisfies a first environment threshold.

9. The control module of claim 8, wherein:
the first environment sensor is a temperature sensor;
the first environment condition is a temperature; and
the first environment threshold is a predetermined temperature range.

10. The control module of claim 8, wherein:
the first environment sensor is a motion sensor;
the first environment condition is a motion amount of a portion of the tool string; and
the first environment threshold is a motion threshold.

11. The control module of claim 1, wherein the logic circuit is configured to implement a predetermined time delay between initiation of consecutive wellbore tools of the plurality of wellbore tools.

12. The control module of claim 11, wherein:
the logic circuit further comprises:
a first microcontroller configured to calculate a first timing after initiation of a wellbore tool;
a second microcontroller configured to calculate a second timing after initiation of consecutive wellbore tool; and
the initiation condition comprises the first timing and the second timing being within a predetermined timing range of the predetermined time delay.

13. A tool string for use in a wellbore, the tool string comprising:
a control module;
a plurality of wellbore tools operably coupled in sequence, a topmost wellbore tool of the plurality of wellbore tools being operably coupled to the control module; wherein
each wellbore tool of the plurality of wellbore tools is selectively addressable;
the control module comprises:
a power source; and
a logic circuit operably coupled to the power source;
wherein the logic circuit is operably coupled to the plurality of wellbore tools through the topmost wellbore tool; and
the logic circuit is configured to, in response to an initiation condition:
for each wellbore tool of the plurality of wellbore tools in a sequential order from a bottommost wellbore tool to the topmost wellbore tool, determine whether the wellbore tool is a responsive wellbore tool or a non-responsive wellbore tool;
in response to a determination that the wellbore tool is a responsive wellbore tool, initiate the wellbore tool; and
in response to a determination that the wellbore tool is a non-responsive wellbore tool, skip initiation of the wellbore tool.

14. The tool string of claim 13, wherein:
the control module further comprises a first pressure sensor coupled to the logic circuit, the first pressure sensor being configured to detect a pressure and output a first sensor output signal based on the pressure; and
the initiation condition comprises the first sensor output signal indicating that the pressure is within a predetermined pressure range.

15. The tool string of claim 14, wherein the pressure is a tubing pressure or a wellbore pressure.

16. The tool string of claim 13, wherein:
the control module further comprises a pressure-actuated safety switch operably coupled between the power source and the logic circuit, the pressure-actuated safety switch being configured to close and operably couple the power source to the logic circuit in response to a pressure exceeding a first pressure threshold.

17. The tool string of claim 16, wherein the pressure-actuated safety switch comprises:
a first electrical contact operably coupled to the power source and a second electrical contact spaced apart from the first electrical contact and operably coupled to the logic circuit;
a third electrical contact movable between a first position, in which the third electrical contact is separated from the first electrical contact and the second electrical contact, and a second position, in which the third electrical contact is in contact with the first electrical contact and the second electrical contact thereby operably coupling the first electrical contact to the second electrical contact; and
a bias member configured to bias the third electrical contact toward the first position.

18. The tool string of claim 13, wherein
the logic circuit further comprises a first microcontroller;
a first environment sensor operably coupled to the first microcontroller, the first environment sensor being configured to detect a first environment condition and output a first environment signal based on the first environment condition; and
the initiation condition comprises the first environment signal indicating that the first environment condition satisfies a first environment threshold.

19. The tool string of claim 13, wherein the logic circuit is configured to implement a predetermined time delay between initiation of consecutive wellbore tools of the plurality of wellbore tools.

20. (canceled)

21. A control module for use with a plurality of wellbore tools, the control module comprising:
a top housing configured to be coupled to a tubing, the top housing defining a first cavity configured to be in fluid communication with the tubing;
a bottom housing configured to be operably coupled to a topmost wellbore tool of the plurality of wellbore tools;
a power source;
a logic circuit configured to receive power from the power source, wherein the logic circuit, in response to an initiation condition, is configured to determine whether a wellbore tool of the plurality of wellbore tools is a responsive wellbore tool or a non-responsive wellbore tool; and
a pressure-actuated safety switch in fluid communication with the first cavity of the top housing and operably coupled to the power source and the logic circuit, wherein the logic circuit is configured to receive the power from the power source in response to the pressure-activated switch being activated by a threshold pressure in the first cavity.
